(19) United States
(12) Patent Application Publication
(10) Pub. No.: US 2025/0319590 A1
(43) Pub. Date: Oct. 16, 2025

(54) ADJUSTMENT OF MANIPULATED VALUE OF ROBOT

(71) Applicant: KABUSHIKI KAISHA YASKAWA DENKI, Kitakyushu-shi (JP)

(72) Inventors: Hiroki TACHIKAKE, Fukuoka (JP); Tsuyoshi YOKOYA, Fukuoka (JP); Ryo KABUTAN, Fukuoka (JP); Makoto TAKAHASHI, Fukuoka (JP); Ryo MASUMURA, Fukuoka (JP)

(73) Assignee: KABUSHIKI KAISHA YASKAWA DENKI, Kitakyushu-shi (JP)

(21) Appl. No.: 19/250,746

(22) Filed: Jun. 26, 2025

Related U.S. Application Data
(63) Continuation of application No. PCT/JP2024/002501, filed on Jan. 26, 2024.
(60) Provisional application No. 63/481,798, filed on Jan. 27, 2023.

(51) Int. Cl. B25J 9/16

(52) U.S. Cl. CPC B25J 9/1661; B25J 9/163; B25J 9/1697

(57) ABSTRACT

A robot control system includes circuitry configured to: acquire observation data indicating a current situation of a real working space; initially set, based on the observation data, a next manipulated value in a current task for a robot placed in the real working space and executing the current task to process a workpiece; virtually execute, by simulation, the current task in which the robot operates with the next manipulated value to process the workpiece, and to generate, as a predicted state, a state of the workpiece processed by the robot; calculate, based on a goal value preset in association with the workpiece, an evaluation value of the predicted state of the workpiece; adjust the next manipulated value based on the evaluation value; and control the robot in the real working space based on the adjusted next manipulated value.

### CROSS-REFERENCE TO RELATED APPLICATIONS

This application is a continuation application of PCT Application No. PCT/JP2024/002501, filed on Jan. 26, 2024, which claims the benefit of priority from U.S. Provisional Patent Application No. 63/481,798, filed on Jan. 27, 2023. The entire contents of the above listed PCT and priority applications are incorporated herein by reference.

### BACKGROUND

### Field

One aspect of the present disclosure relates to a robot control system, a robot control method, and a robot control program.

### Description of the Related Art

Japanese Patent No. 7021158 describes a robot system including an acquisition unit that acquires first input data determined in advance as data affecting an operation of a robot, a calculation unit that calculates, based on the first input data, a calculation cost of inference processing using a machine learning model that infers control data used for control of the robot, an inference unit that infers the control data by the machine learning model set according to the calculation cost, and a drive control unit that controls the robot using the inferred control data.

### SUMMARY

A robot control system according to an aspect of the present disclosure includes circuitry configured to: acquire observation data indicating a current situation of a real working space; initially set, based on the observation data, a next manipulated value in a current task for a robot placed in the real working space and executing the current task to process a workpiece; virtually execute, by simulation, the current task in which the robot operates with the next manipulated value to process the workpiece, and to generate, as a predicted state, a state of the workpiece processed by the robot; calculate, based on a goal value preset in association with the workpiece, an evaluation value of the predicted state of the workpiece; adjust the next manipulated value based on the evaluation value; and control the robot in the real working space based on the adjusted next manipulated value.

A robot control method according to an aspect of the present disclosure is executable by a robot control system including at least one processor. The method includes: acquiring observation data indicating a current situation of a real working space; initially setting, based on the observation data, a next manipulated value in a current task for a robot placed in the real working space and executing the current task to process a workpiece; virtually executing, by simulation, the current task in which the robot operates with the next manipulated value to process the workpiece, and generating, as a predicted state, a state of the workpiece processed by the robot; calculating, based on a goal value preset in association with the workpiece, an evaluation value of the predicted state of the workpiece; adjusting the next manipulated value based on the evaluation value; and controlling the robot in the real working space based on the adjusted next manipulated value.

A non-transitory computer-readable storage medium stores processor-executable instructions for causing a computer to execute: acquiring observation data indicating a current situation of a real working space; initially setting, based on the observation data, a next manipulated value in a current task for a robot placed in the real working space and executing the current task to process a workpiece; virtually executing, by simulation, the current task in which the robot operates with the next manipulated value to process the workpiece, and generating, as a predicted state, a state of the workpiece processed by the robot; calculating, based on a goal value preset in association with the workpiece, an evaluation value of the predicted state of the workpiece; adjusting the next manipulated value based on the evaluation value; and controlling the robot in the real working space based on the adjusted next manipulated value.

### BRIEF DESCRIPTION OF THE DRAWINGS

FIG. 1 is a diagram showing an example application of a robot control system.

FIG. 2 is a diagram showing an example functional configuration of the robot control system.

FIG. 3 is a diagram showing an example hardware configuration of a computer used for the robot control system.

FIG. 4 is a flowchart showing an example of determining a next manipulated value and controlling a robot.

FIG. 5 is a diagram showing an architecture associated with the determination of the next manipulated value.

FIG. 6 is a diagram showing an example architecture related to simulation.

FIG. 7 is a flowchart showing an example task control.

### DETAILED DESCRIPTION

In the following description, with reference to the drawings, the same reference numbers are assigned to the same components or to similar components having the same function, and overlapping description is omitted.

### Overview of System

A robot control system according to the present disclosure is a computer system for autonomously operating a real robot according to a current situation of a real working space. In one example, the robot control system determines a next manipulated value of a robot in a current task, the robot being deployed in the real working space and executing the current task to process a workpiece, and causes the robot to continue the current task based on the next manipulated value. In the present disclosure, the task refers to an operation to be executed by the robot in order to achieve a certain purpose. For example, the task is to process a workpiece. The robot executes the task, and a result desired by a user of the robot control system is obtained. The current task refers to a task that is currently executed by the robot. In the present disclosure, the manipulated value or manipulated variable refers to information for generating a motion of the robot. Examples of the manipulated value include an angle of each joint of the robot (joint angle) and a torque at each joint (joint torque). The next manipulated value refers to a manipulated value of the robot in a predetermined time width after the current point in time.

The robot control system does not determine the next manipulated value of the robot according to a goal posture or a path planned in advance, but determines the next manipulated value according to the current situation of the working space that is difficult to be accurately predicted in advance. For example, the robot control system determines an attribute (e.g., type, state, etc.) of the actual workpiece to be processed, as a current status of the working space, and conclude the next manipulated value based on the determination. By such control, the robot operation according to the workpiece may be realized. For example, the robot control system determines, in accordance with a current situation of a workpiece whose state transition is not reproducible, the next manipulated value of the robot that processes the workpiece. Alternatively, the robot control system determines, in accordance with a current situation of a workpiece with an indefinite appearance, the next manipulated value of the robot that processes the workpiece. The robot control system causes the robot to execute the current task based on the determined next manipulated value.

In the present disclosure, the workpiece refers to a tangible object that is directly or indirectly affected by a motion of the robot. The workpiece may be a tangible object directly processed by the robot, or may be another tangible object existing around the tangible object directly processed by the robot. For example, in a case where the current task is a process of opening a packaging material that wraps a certain product, the workpiece may be at least one of the packaging material and the product. As another example, in a case where the current task is a process of packing a product having an indefinite appearance into a container, the workpiece may be at least one of the product and the container. The “workpiece whose state transition is not reproducible” refers to a workpiece for which it is difficult to predict what state will be obtained next or what state will be obtained last. It may be said that the “workpiece whose state transition is not reproducible” is a workpiece whose state changes irregularly. An example of the workpiece whose state transition is not reproducible is a tangible object, such as packaging material or a bag made from a soft resin, whose external shape changes irregularly due to an external force (for example, an operation of the robot). The “workpiece having an indefinite appearance” refers to that the appearance is not completely the same between individual workpieces. Examples of the tangible object having an indefinite appearance include fresh foods such as vegetables, fruits, fish, and meat.

In order to robustly control the robot according to the current situation, the robot control system initially sets the next manipulated value and virtually executes, by simulation, the current task in which the robot operates with the next manipulated value to process the workpiece. The simulation is a process of not actually operating a real robot placed in the real working space but expressing the operation of the robot in a simulated manner on a computer. The robot control system adjusts the next manipulated value based on a prediction result obtained by the simulation, and controls the real robot based on the adjusted next manipulated value. That is, the robot control system predicts the state of the workpiece at a slightly later time, and adjusts and determines the next manipulated value in consideration of the prediction result.

In one example, the robot control system controls, based on an execution status of the current task, whether or not to continue the current task without changing an action position that is a position at which the robot acts on the workpiece, or to continue the current task after changing the action position. The action position is, for example, a position at which the robot holds the workpiece with an end effector. In another example, the robot control system controls whether or not to continue the current task according to the execution status of the current task. The robot control system may plan a next task following the current task, based on the execution status of the current task, and may terminate the current task according to a result of the planning. These controls are also examples of autonomously operating the real robot according to the current situation of the real working space.

### Configuration of System

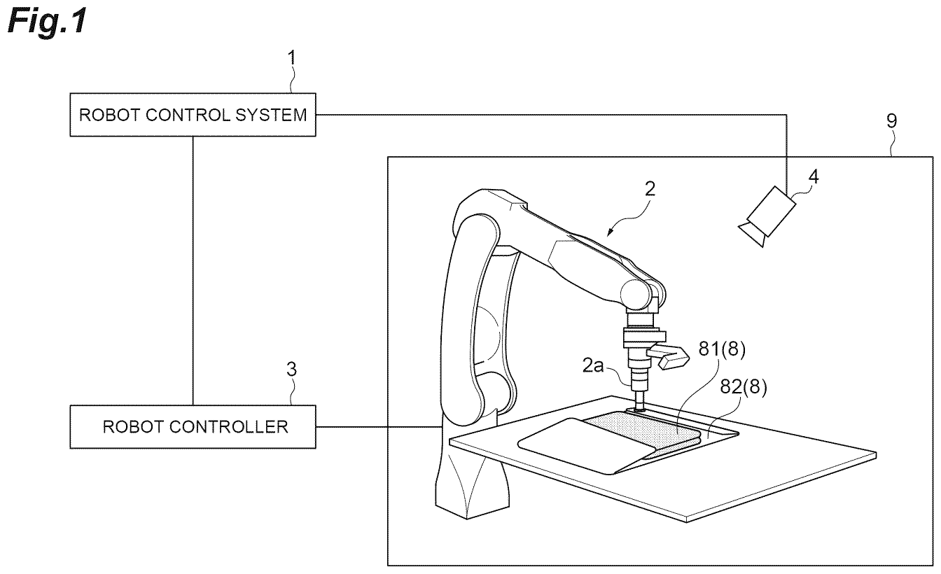

FIG. 1 is a diagram showing an example application of the robot control system. A robot control system 1 shown in this example causes a real robot 2 which is placed in a real working space 9 and processes a real workpiece 8 to operate autonomously according to the current situation of the working space 9. The robot control system 1 is connected to a robot controller 3 that controls the robot 2 and a camera 4 that shoots the working space 9, via a communication network. The communication network may be a wired network or a wireless network. The communication network may include at least one of the Internet and an intranet. Alternatively, the communication network may be implemented simply by a single communication cable.

The example of FIG. 1 shows a product 81 and a sheet-like packaging material 82 encasing the product 81, as workpieces 8. In the current task, the robot 2 opens the packaging material 82 enclosing the product 81, while changing the holding position in the packaging material 82. Therefore, in the current task, the packaging material 82 is a workpiece directly processed by the robot 2, and the product 81 is a workpiece indirectly affected by a motion of the robot 2 (i.e., work by the robot 2). In the next task, the robot 2 may process the product 81 directly, for example, by moving the product 81 away from the packaging material 82 to another place.

The robot 2 is a device that receives power, performs a predetermined operation according to a purpose, and executes useful work. In one example, the robot 2 includes a plurality of joints, an arm, and an end effector 2a attached to a tip of the arm. The robot 2 uses the end effector 2a to perform unpacking operations, and may further perform additional operations in one example. Examples of the end effector 2a include a gripper, a suction hand, and a magnetic hand. A joint axis is set for each of the plurality of joints. Some components of the robot 2, such as the arm and a pivoting unit, rotate about the joint axis, so that the robot 2 may change a position and a posture of the end effector 2a within a predetermined range. In one example, the robot 2 is a multi-axis, serial-link, vertically articulated robot. The robot 2 may be a six-axis vertically articulated robot, or may be a seven-axis vertically articulated robot in which one redundant axis is added to six axes. The robot 2 may be a movable robot, for example, an autonomous mobile robot (AMR) or a robot supported by an automated guided vehicle (AGV). Alternatively, the robot 2 may be a stationary robot that is fixed in a predetermined place.

The robot controller 3 is a device that controls the robot 2 according to an operation program generated in advance. In one example, the robot controller 3 receives, from the robot control system 1, a manipulated value of the robot for matching the position and posture of the end effector with a goal value indicated by the operation program, and controls the robot 2 according to the manipulated value. In addition, the robot controller 3 transmits the manipulated value to the robot control system 1. As described above, examples of the manipulated value include the joint angle (the angle of each joint) and the joint torque (the torque at each joint).

The camera 4 is a device that captures at least a part of the area in the working space 9 and generates image data indicating a situation in that area as a situation image. In one example, the camera 4 captures at least the workpiece 8 being processed by the robot 2 and generates a situation image showing the current situation of the workpiece 8. The camera 4 transmits the situation image to the robot control system 1. The camera 4 may be fixed to a pole, a roof, or the like, or may be attached near the tip of the arm of the robot 2.

In the present disclosure, image data and various images may be a still image, or may be a set of one or more frame images selected from a plurality of frame images constituting a video.

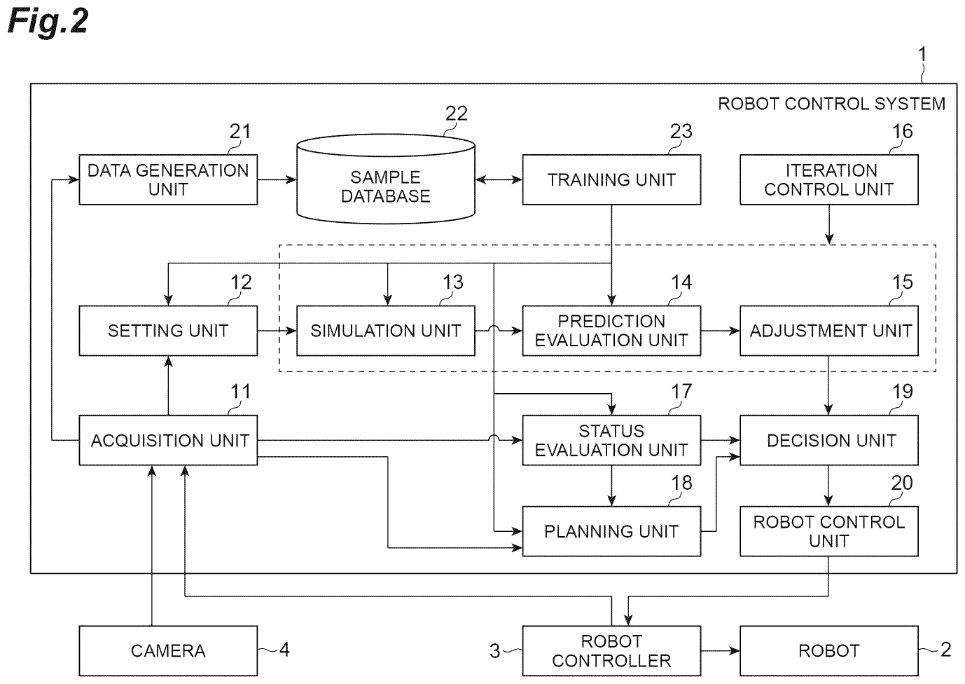

FIG. 2 is a diagram showing an example functional configuration of the robot control system 1. In this example, the robot control system 1 includes an acquisition unit 11, a setting unit 12, a simulation unit 13, a prediction evaluation unit 14, an adjustment unit 15, an iteration control unit 16, a status evaluation unit 17, a planning unit 18, a decision unit 19, a robot control unit 20, a data generation unit 21, a sample database 22, and a training unit 23 as the functional components.

The acquisition unit 11 is a functional module that acquires, from the robot controller 3 and the camera 4, data that is to be used to determine the next manipulated value in the current task. The setting unit 12 is a functional module that initially sets the next manipulated value. The simulation unit 13 is a functional module that virtually executes, by simulation, the current task in which the robot 2 operates with the next manipulated value to process the workpiece 8. The prediction evaluation unit 14 is a functional module that calculates an evaluation value for a prediction result of the simulation based on a goal value preset in association with the workpiece 8. In the present disclosure, this evaluation value is also referred to as a “prediction evaluation value”. The adjustment unit 15 is a functional module that adjusts the next manipulated value based on the prediction evaluation value. The iteration control unit 16 is a functional module that controls the simulation unit 13, the prediction evaluation unit 14, and the adjustment unit 15 to repeat the simulation, the calculation of the prediction evaluation value, and the adjustment of the next manipulated value. The status evaluation unit 17 is a functional module that calculates an evaluation value related to an execution status of the current task (e.g., a current state of the workpiece 8 being processed) based on the goal value preset in association with the workpiece 8. In the present disclosure, this evaluation value is also referred to as a “status evaluation value”. The planning unit 18 is a functional module that plans the next task based on the execution status of the current task. The decision unit 19 is a functional module that concludes a next operation of the robot 2 based on at least one of the adjusted next manipulated value, the execution status of the current task, and the plan of the next task. The robot control unit 20 is a functional module that controls the robot 2 based on the conclusion.

The data generation unit 21, the sample database 22, and the training unit 23 are functional modules for generating a trained model used to control the robot 2. The trained model is generated by machine learning that is a method of autonomously finding a law or a rule by iteratively learning based on given information. The data generation unit 21 is a functional module that generates at least part of training data used in the machine learning, based on the operation of the robot 2 currently executing the task or the state of the workpiece 8 currently processed in the current task. The sample database 22 is a functional module that stores the training data generated by the data generation unit 21 and training data collected in advance before the robot 2 executes the current task. That is, the sample database 22 may store both training data collected in advance and training data obtained while the robot 2 is executing the current task. The training unit 23 is a functional module that generates the trained model by machine learning using the training data in the sample database 22. In one example, the training unit 23 generates at least one of a control model used by the setting unit 12, a state prediction model used by the simulation unit 13, an evaluation model used by the prediction evaluation unit 14 and the status evaluation unit 17, and a planning model used by the planning unit 18. These trained models are implemented by, for example, a neural network such as a deep neural network (DNN). By generating the trained model by the machine learning, it is possible to quantify the evaluation of the workpiece 8 or the task based on tacit knowledge (knowledge based on human experience or intuition) and appropriately control the robot 2.

The robot control system 1 may be implemented by any type of computer. The computer may be a general-purpose computer such as a personal computer or a business server, or may be incorporated in a dedicated device that executes particular processing.

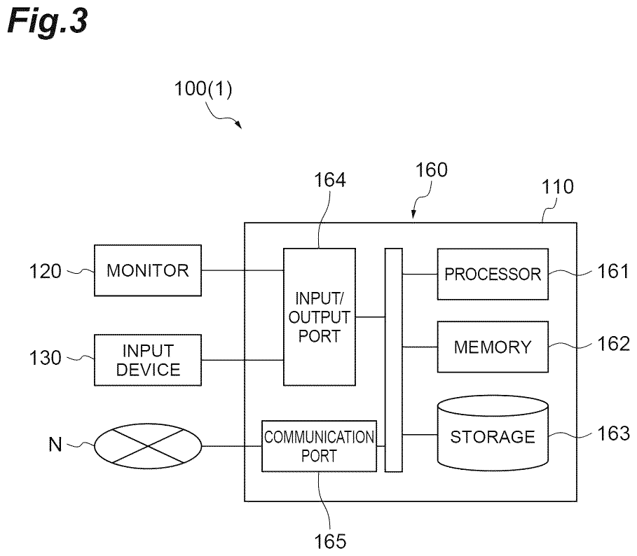

FIG. 3 is a diagram showing an example hardware configuration of a computer 100 used for the robot control system 1. In this example, the computer 100 includes a main body 110, a monitor 120, and an input device 130.

The main body 110 is a device having circuitry 160. The circuitry 160 has a processor 161, a memory 162, a storage 163, an input/output port 164, and a communication port 165. The number of each hardware component may be 1 or 2 or more. The storage 163 stores a program for configuring each functional module of the main body 110. The storage 163 is a computer-readable recording medium such as a hard disk, a nonvolatile semiconductor memory, a magnetic disk, or an optical disc. The memory 162 temporarily stores a program loaded from the storage 163, calculation results by the processor 161, and the like. The processor 161 configures each functional module by executing the program in cooperation with the memory 162. The input/output port 164 inputs and outputs electrical signals to and from the monitor 120 or the input device 130 in response to commands from the processor 161. The communication port 165 performs data communication with other devices such as the robot controller 3 via communication network N in accordance with commands from the processor 161.

The monitor 120 is a device for displaying information output from the main body 110. For example, the monitor 120 is a device capable of graphic display, such as a liquid-crystal panel.

The input device 130 is a device for inputting information to the main body 110. Examples of the input device 130 include operation interfaces such as a keypad, a mouse, and a manipulation controller.

The monitor 120 and the input device 130 may be integrated as a touch panel. For example, the main body 110, the monitor 120, and the input device 130 may be integrated like a tablet computer.

Each functional module in the robot control system 1 is implemented by loading a robot control program on the processor 161 or the memory 162 and executing the program in the processor 161. The robot control program includes codes for implementing each functional module of the robot control system 1. The processor 161 operates the input/output port 164 and the communication port 165 according to the robot control program, and executes reading and writing of data in the memory 162 or the storage 163.

The robot control program may be provided by being recorded in a non-transitory recording medium such as a CD-ROM, a DVD-ROM, or a semiconductor memory. Alternatively, the robot control program may be provided via a communication network as data signals superimposed on carrier waves.

### Robot Control Method

### Robot Control Based on Next Manipulated Value

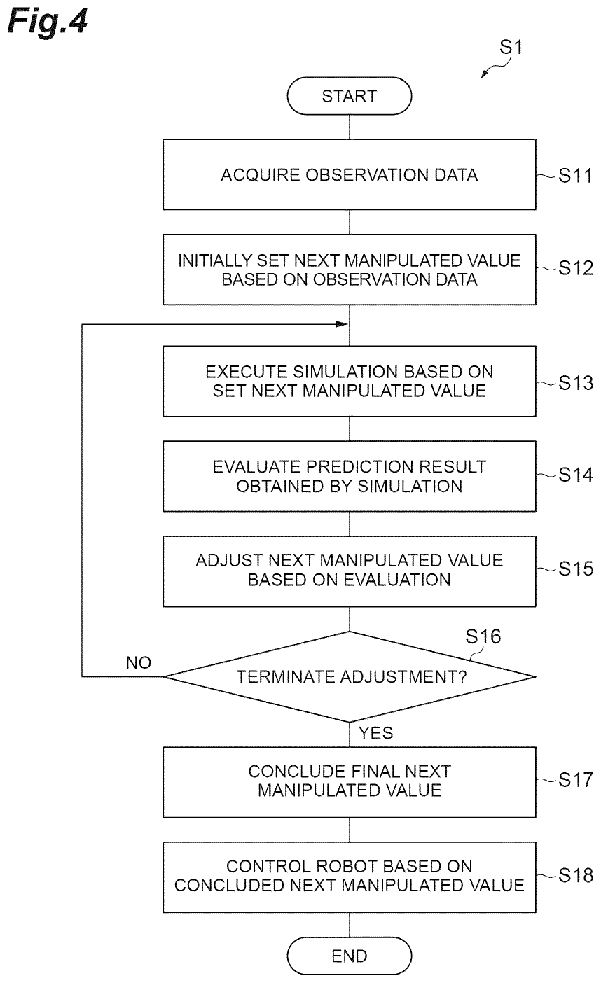

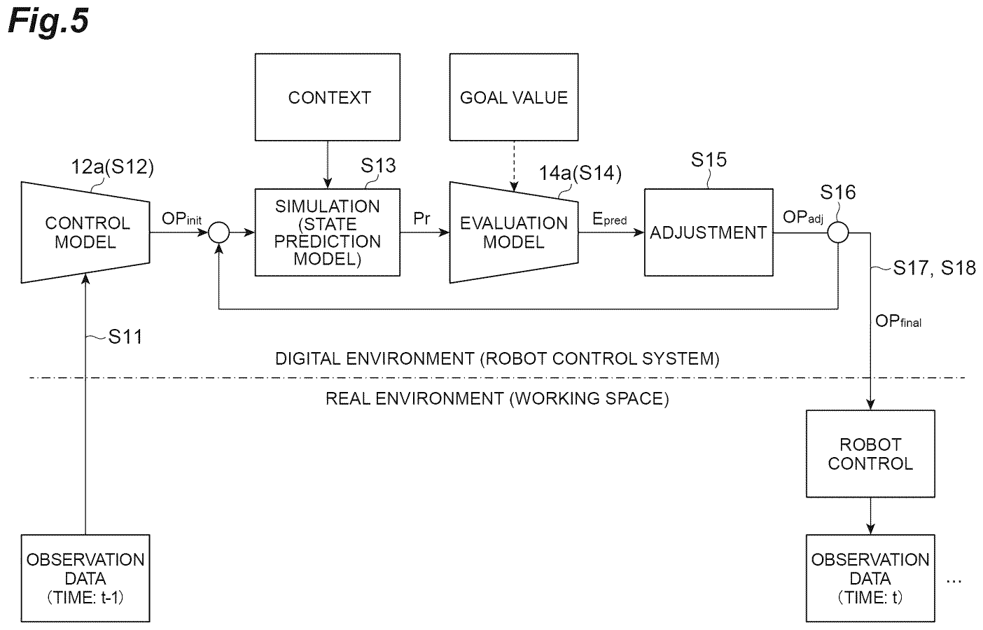

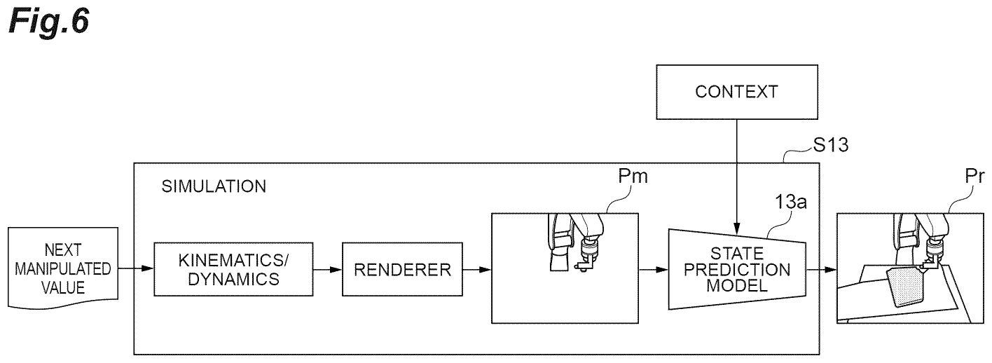

As examples of the robot control method according to the present disclosure, examples of controlling the robot by determining the next manipulated value will be described with reference to FIGS. 4 to 6. FIG. 4 is a flowchart showing the series of processes as a processing flow S1. That is, the robot control system 1 executes the processing flow S1. FIG. 5 is a diagram showing an architecture associated with determination of the next manipulated value. In FIG. 5, the time (t−1) is the current point in time, and the time t is a point in time at which the robot control based on the next manipulated value is executed, that is, a point in time slightly after the current point in time. FIG. 6 is a diagram showing an example architecture related to simulation.

In step S11, the acquisition unit 11 acquires observation data indicating a current status of the working space 9. For example, the acquisition unit 11 acquires a manipulated value of the robot 2 that processes the workpiece 8 as a current manipulated value, from the robot controller 3, and acquires a situation image indicating the workpiece 8 that is processed by the robot 2, from the camera 4. That is, the observation data may include the current manipulated value and the situation image.

In step S12, the setting unit 12 initially sets the next manipulated value OPᵢₙᵢₜ of the robot 2 in the current task based on the observation data. The setting unit 12 inputs the situation image and the current manipulated value into a control model 12a to initially set the next manipulated value OPᵢₙᵢₜ. The control model 12a is a trained model that is trained to calculate, based on a sample image indicating a workpiece at a first point in time and a first manipulated value of the robot 2 at the first point in time, a second manipulated value of the robot 2 at a second point in time after the first point in time.

In step S13, the simulation unit 13 executes simulation based on the set next manipulated value. In the first loop processing, the simulation unit 13 virtually executes, by the simulation, the current task in which the robot 2 operates with the next manipulated value OPᵢₙᵢₜ to process the workpiece 8. In one example, the simulation unit 13 uses a robot model indicating the robot 2 and a context regarding an element constituting the working space 9 (hereinafter, also referred to as a “component”), for the simulation. The robot model is electronic data indicating specifications related to the robot 2 and the end effector 2a. The specifications may include parameters related to structures of the robot 2 and the end effector 2a, such as shape, dimensions, etc., and parameters related to functions the robot 2 and the end effector 2a, such as a movable range of each joint, capabilities of the end effector 2a, etc. The context refers to electronic data indicating various attributes of each of one or more components of the working space 9, and may be expressed by, for example, text (i.e., natural language). It may be said that the element constituting the working space 9 is a tangible object existing in the working space 9. The context may include various attributes of the workpiece 8, such as type, shape, physical properties, dimensions, and color of the workpiece 8. Alternatively, the context may include various attributes of the robot 2 or the end effector 2a, such as type, shape, size and color of the robot 2 or the end effector 2a. Alternatively, the context may include attributes of surrounding environment of the robot 2 and workpiece 8. Examples of attributes of the surrounding environment include type, shape, and color of work table, type and color of floor, and type and color of wall. As described above, the context may include at least one of workpiece information related to the workpiece 8, robot information (robot model) related to the robot 2, and environmental information related to the surrounding environment. Based on the robot model, the context, and the set next manipulated value, the simulation unit 13 generates a prediction result including a predicted state of the workpiece 8 in a predetermined time width in the future including the time t. The prediction result may further include a motion of the robot 2 in that time width.

An example of the simulation will be described in detail with reference to FIG. 6. In this example, the simulation unit 13 executes kinematics/dynamics calculations based on the next manipulated value to generate a virtual motion of the robot 2 operating at the next manipulated value. By this processing, a motion is generated in consideration of geometric constraints (kinematics) and mechanical constraints (dynamics) of the robot 2. Subsequently, the simulation unit 13 uses a renderer to generate a motion image Pm showing a virtual motion of the robot 2. Since the virtual motion is generated based on the next manipulated value, the renderer that renders the virtual motion may be said to be a process based on the next manipulated value. In one example, the simulation unit 13 uses differentiable kinematics/dynamics and a differentiable renderer to generate the motion image Pm from the next manipulated value. This example may be implemented to make a series of processes from the input of the next manipulated value to the output of the prediction evaluation value differentiable in order to use backpropagation for reducing the prediction evaluation value.

The simulation unit 13 inputs the virtual motion indicated by the motion image Pm and the context to a state prediction model 13a, and generates a state of the workpiece 8 processed by the robot 2 that operates with the next manipulated value as the predicted state. The predicted state may indicate a temporal change in the situation of the workpiece 8 in a predetermined time width in the future including the time t. The predicted state may further indicate a motion of the robot 2 in that time width. In one example, the state prediction model 13a generates a predicted image Pr showing the predicted state. The state prediction model 13a is a trained model that is trained to predict a state of the workpiece 8 based on the motion of the robot 2 and the context. The simulation unit 13 may generate a temporal change in a virtual appearance state of the workpiece 8 due to the virtual motion of the robot 2, as the predicted state (the predicted image Pr). The appearance state of the workpiece refers to, for example, the shape of the appearance of the workpiece.

Refer back to FIGS. 4 and 5. In step S14, the prediction evaluation unit 14 evaluates the prediction result obtained by the simulation. In one example, the prediction evaluation unit 14 calculates a prediction evaluation value E_{pred}, which is an evaluation value of the predicted state of the workpiece 8, based on a preset goal value related to the workpiece 8. In one example, the goal value is represented by a goal image, which is an image indicating a predetermined state of the workpiece 8 to be compared with the predicted state. The goal value may be a final state of the workpiece 8 in the current task, and in this case, the goal image indicates the final state. Alternatively, the goal value may be a state of the workpiece 8 at a time point in the middle of the current task (intermediate state), and may be, for example, an intermediate state of the workpiece 8 at a time point at which the next manipulated value is actually applied (time t in the example of FIG. 5). In this case, the goal image indicates the intermediate state. The prediction evaluation value E_{pred} indicates how close the predicted state of the workpiece 8 is to the goal value. In the present disclosure, the smaller the prediction evaluation value E_{pred} is, the closer the predicted state is to the goal value. In one example, the prediction evaluation unit 14 inputs the predicted image Pr and the goal image into an evaluation model 14a to calculate the prediction evaluation value E_{pred}. The evaluation model 14a is a trained model that is trained to calculate an evaluation value based on a state of the workpiece 8 and a goal value (for example, based on an image indicating a state of the workpiece 8 and a goal image indicating a goal value).

In step S15, the adjustment unit 15 adjusts the next manipulated value based on the evaluation of the prediction result (predicted state). For example, the adjustment unit 15 adjusts the next manipulated value based on an evaluation of a temporal change in the virtual appearance state of the workpiece 8. The adjustment unit 15 may adjust the next manipulated value such that the state of the workpiece 8 is closer to the goal value than the predicted state, and set an adjusted next manipulated value OP_{adj}. The adjustment unit 15 may increase the adjustment amount of the next manipulated value as the prediction evaluation value E_{pred} increases, that is, as the predicted state deviates from the goal value.

In step S16, the iteration control unit 16 determines whether or not to terminate the adjustment of the next manipulated value based on a predetermined termination condition. The termination condition may be that the iteration process has been repeated a predetermined number of times, or that a predetermined calculation time has elapsed. Alternatively, the termination condition may be that the difference between the previously obtained prediction evaluation value E_{pred} and the currently obtained prediction evaluation value E_{pred} becomes equal to or less than a predetermined threshold, that is, the prediction evaluation value E_{pred} stays or converges.

In a case where the next manipulated value is to be further adjusted (NO in step S16), the process returns to step S13. In the repeated step S13, the simulation unit 13 executes the simulation based on the set next manipulated value OP_{adj}. The simulation unit 13 executes the simulation based on the set next manipulated value OP_{adj} and the context to generate at least a predicted state of the workpiece 8 in a predetermined time width in the future including the time t. Since the next manipulated value OP_{adj} used in the current loop processing is different from any next manipulated value used in the past loop processing, the predicted state obtained in the current loop processing may be different from any predicted state used in the past loop processing. As described above, the simulation unit 13 may generate the predicted image Pr indicating the predicted state. In the repeated step S14, the prediction evaluation unit 14 inputs the predicted state obtained this time (predicted image Pr) and the goal value (goal image) into the evaluation model 14a to calculate the prediction evaluation value E_{pred}. In the repeated step S15, the adjustment unit 15 further adjusts the next manipulated value based on the prediction evaluation value E_{pred}. By such an iteration process, a plurality of adjusted next manipulated value OP_{adj} is obtained.

In a case where the adjustment is to be terminated (YES in step S16), the process proceeds to step S17. In step S17, the decision unit 19 concludes a final next manipulated value OP_{final} from the plurality of next manipulated values OP_{adj}. For example, the decision unit 19 concludes the next manipulated value OP_{adj} finally obtained by the iteration process as the next manipulated value OP_{final}. Alternatively, the decision unit 19 may conclude the next manipulated value OP_{adj} at which the state of the workpiece 8 is expected to converge to the goal value associated with the workpiece 8, as the next manipulated value OP_{final}. For example, the decision unit 19 concludes, as the next manipulated value OP_{final}, the next manipulated value OP_{adj} that is expected to cause the workpiece 8 to converge to the goal value earliest.

In step S18, the robot control unit 20 controls the actual robot 2 in the working space 9 based on the next manipulated value OP_{final}. Since the next manipulated value OP_{final} is one of the plurality of next manipulated values OP_{adj}, it may be said that the robot control unit 20 controls the robot 2 based on the adjusted next manipulated value OP_{adj}. The robot control unit 20 transmits the next manipulated value OP_{final} to the robot controller 3 in order to control the robot 2. The robot controller 3 controls the robot 2 according to the manipulated value OP_{final}. The robot 2 continues to execute the current task according to the control to further process the workpiece 8.

The robot control system 1 may repeatedly execute the processing flow S1 at predetermined time intervals. In the example of FIG. 5, the robot control system 1 executes the processing flow S1 based on the observation data at time (t−1) to determine the next manipulated value at time t. The real robot 2 processes the real workpiece 8 based on that manipulated value. The robot control system 1 acquires the manipulated value at time t as the current manipulated value from the robot controller 3, and acquires the situation image indicating the state of the workpiece 8 at time t from the camera 4. The robot control system 1 executes the processing flow S1 based on these observation data to determine the next manipulated value at time (t+1). The real robot 2 further processes the real workpiece 8 based on the manipulated value. The robot control system 1 causes the robot 2 to execute the current task while sequentially generating the next manipulated value by repeating such processing.

### Task Control

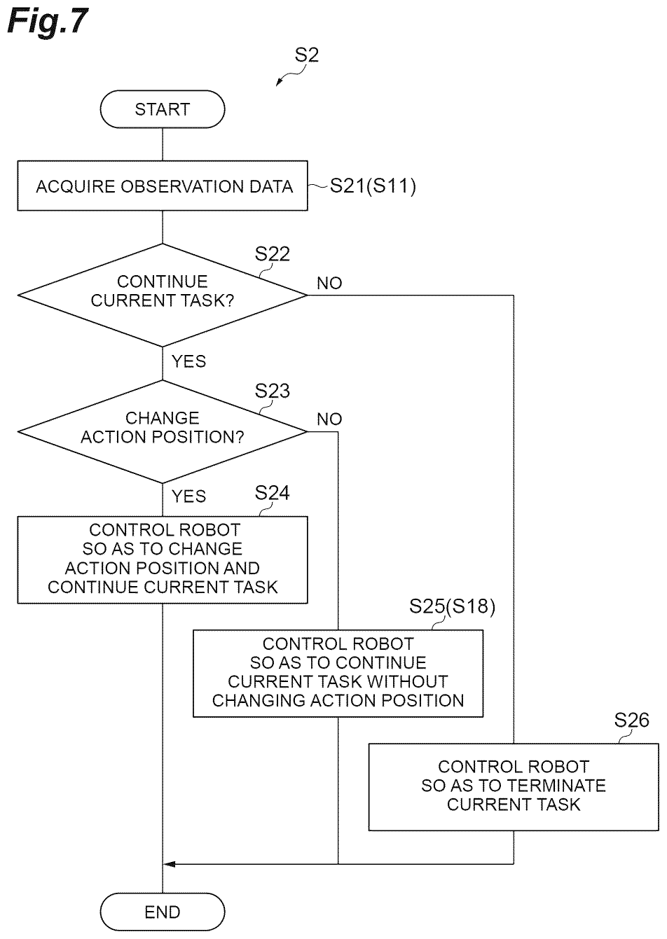

As examples of the robot control method according to the present disclosure, examples of task control will be described with reference to FIG. 7. FIG. 7 is a flowchart showing a series of procedures of task control as a processing flow S2. That is, the robot control system 1 executes the processing flow S2. In one example, the robot control system 1 executes the processing flows S1 and S2 in parallel.

In step S21, the acquisition unit 11 acquires the observation data indicating the current status of the working space 9. This process is the same as step S11. As described above, the acquisition unit 11 may acquire the current manipulated value and the situation image as the observation data.

In step S22, the decision unit 19 determines whether or not to continue the current task. For this determination, the status evaluation unit 17 calculates a status evaluation value, which is an evaluation value related to the execution status of the current task, based on the goal value preset in association with the workpiece 8. In one example, the goal value is represented by a goal image, which is an image indicating a predetermined state of the workpiece 8 to be compared with the current state of the workpiece 8 represented by the situation image. The goal value may be a final state of the workpiece 8 in the current task, and in this case, the goal image indicates the final state. The status evaluation value indicates how close the execution status of the current task (e.g., the current state of the workpiece 8) is to the goal value. In the present disclosure, the smaller the status evaluation value is, the closer the execution status of the current task (e.g., the current state of the workpiece 8) is to the goal value. In one example, the status evaluation unit 17 inputs the situation image and the goal image into the evaluation model to calculate the status evaluation value. The decision unit 19 switches whether or not to continue the current task, based on the status evaluation value. Therefore, the decision unit 19 also functions as the determination unit. For example, the decision unit 19 determines to continue the current task if the status evaluation value is greater than or equal to a predetermined threshold, and determines to terminate the current task if the status evaluation value is less than the threshold. In a case where the current task is to be continued (YES in step S22), the process proceeds to step S23, and in a case where the current task is to be terminated (NO in step S22), the process proceeds to step S26.

In step S23, the decision unit 19 determines whether or not to change the action position in the current task. For this determination, the status evaluation unit 17 calculates a status evaluation value, which is an evaluation value related to the execution status of the current task, based on a goal value preset in association with the workpiece 8. Similar to step S22, the status evaluation unit 17 may calculate the evaluation value for the current state of the workpiece 8 as the execution status of the current task. Unlike step S22, the goal value in step S23 may be an ideal state of the workpiece 8 (an intermediate state) at a time point in the middle of the current task. In this case, the goal image indicates the intermediate state. In one example, the status evaluation unit 17 inputs the current image and the goal image into the evaluation model to calculate the status evaluation value. The decision unit 19 determines whether or not to change the action position from the current position based on the status evaluation value. For example, the decision unit 19 determines to change the action position if the status evaluation value is greater than or equal to a predetermined threshold, and determines not to change the action position if the status evaluation value is less than the threshold. In a case where the action position is to be changed (YES in step S23), the process proceeds to step S24, and in a case where the action position is not to be changed (NO in step S24), the process proceeds to step S25.

In step S24, the robot control unit 20 controls the robot 2 so as to change the action position and continue the current task. For example, the robot control unit 20 analyzes the situation image to search and determine a new action position. Then, the robot control unit 20 generates a command for changing the action position from the current position to the new position, and transmits the command to the robot controller 3. The robot controller 3 controls the robot 2 according to the command. In accordance with that control, the robot 2 changes the action position from the current position to the new position and continues to execute the current task.

In step S25, the robot control unit 20 controls the robot 2 so as to continue the current task without changing the action position. This process corresponds to step S18 described above. The robot control unit 20 controls the robot 2 based on the next manipulated value OP_{final} determined by the processing flow S1. The robot control unit 20 transmits the next manipulated value OP_{final} to the robot controller 3 in order to control the robot 2. The robot controller 3 controls the robot 2 according to the manipulated value OP_{final}. According to that control, the robot 2 continues to execute the current task without changing the action position to further process the workpiece 8.

In step S26, the robot control unit 20 controls the robot 2 so as to terminate the current task. In one example, for this processing, the planning unit 18 inputs the situation image into a planning model to generate a plan of the next task following the current task. The planning model is a trained model that is trained to plan the next task based on the current situation of the workpiece 8. According to a result of the plan, the robot control unit 20 controls the robot 2 so as to terminate the current task. For example, the plan of the next task may include a plan of an operation of the robot in the next task, and the robot control unit 20 may control the posture of the robot 2 at the end of the current task such that the robot 2 may smoothly transition to that operation. The robot control unit 20 transmits a command to the robot controller 3 to cause the real robot 2 to terminate the current task. The robot controller 3 causes the robot 2 to terminate the current task according to the command. In one example, the robot control unit 20 further transmits a command for the next task to the robot controller. The robot controller 3 causes the robot 2 to start the next task in accordance with that command.

As shown in the processing flow S2, the robot control unit 20 may control the robot 2 based on a switch (determination) of whether or not to continue the current task, or a determination of whether or not to change the action position.

The robot control system 1 may repeatedly execute the processing flow S2 at predetermined time intervals. As a result of this repetition, the robot 2 continues the current task while changing the action position as necessary to process the workpiece 8, and finally completes the current task.

### Machine Learning

In one example, the training unit 23 generates or updates the at least one trained model used in the robot control system 1 by supervised learning. In the supervised learning, training data (sample data) is used that includes a plurality of data records indicating a combination of input data to be processed by a machine learning model and ground truth of output data from the machine learning model. The training unit 23 executes the following processing for each data record of the training data. That is, the training unit 23 inputs the input data indicated by the data record to the machine learning model. The training unit 23 executes backpropagation based on an error between the output data estimated by the machine learning model and the ground truth indicated by the data record, and updates the parameters in the machine learning model. The training unit 23 repeats the process for each data record until a predetermined termination condition is met, in order to generate or update the trained model. The termination condition may be to process all data records of the training data. It should be noted that each trained model that is generated or updated is a calculation model that is estimated to be optimal, and is not necessarily a “calculation model that is actually optimal”.

The generation or update of the control model will be described. In one example, the data generation unit 21 generates a data record that includes a combination of the current manipulated value and the situation image obtained by the acquisition unit 11 and the next manipulated value adjusted based on the current manipulated value (e.g., the finally determined next manipulated value). The data generation unit 21 stores the data record in the sample database 22 as at least part of the training data. The training unit 23 updates the control model by machine learning using the data record. In this machine learning, the training unit 23 uses the adjusted next manipulated value (e.g., the finally determined next manipulated value) as the ground truth.

As another example, the data generation unit 21 generates a training image from the predicted image Pr generated by the simulation unit 13 (state prediction model). The data generation unit 21 changes the predicted image based on change information for changing the scene indicated by the predicted image, that is, the scene indicating the predicted state, and obtains a training image indicating another state different from the predicted state. The change information may be information for changing the workpiece indicated by the predicted image. For example, the change information may be information for changing a predicted image indicating a scene in which a plastic bag is being processed to a training image indicating a scene in which a hemp sack is being processed. Alternatively, the change information may be information for changing the surrounding environment of the robot 2 and the workpiece 8. For example, the change information may be information for changing a predicted image indicating a scene in which a workpiece placed on a work table is processed to a training image indicating a scene in which a workpiece placed on a floor is processed. The data generation unit 21 may generate a data record including the current manipulated value, the next manipulated value adjusted based on the current manipulated value (e.g., the finally determined next manipulated value), and the training image. The data generation unit 21 stores the data record in the sample database 22 as at least part of the training data. The training unit 23 may update the control model by the machine learning using the data record, or may newly generate another control model for initially setting the next manipulated value. In any case, in such machine learning, the training unit 23 uses the adjusted next manipulated value (e.g., the finally determined next manipulated value) as the ground truth.

The generation or update of the state prediction model will be described. In one example, the data generation unit 21 generates a data record that includes a combination of the adjusted next manipulated value (e.g., the finally determined next manipulated value) and an actual state, which is a state of the actual workpiece 8 having processed by the actual robot 2 controlled by the robot control unit 20 based on the manipulated value. That is, the data generation unit 21 generates a data record including a combination of the adjusted next manipulated value and the situation image obtained as a result of that manipulated value. The data generation unit 21 stores the data record in the sample database 22 as at least part of the training data. The training unit 23 may update the state prediction model by machine learning using the data record, or may generate a new state prediction model. In this machine learning, the training unit 23 generates a virtual motion of the robot 2 from the next manipulated value indicated by the training data, using kinematics/dynamics and a renderer, and inputs the generated motion and a predetermined context to the machine learning model. The training unit 23 uses the situation image as ground truth.

As another example, in a case where the context is expressed by text, the training unit 23 may receive the text indicating the context, compare the text with the predicted state generated by the state prediction model, and update the state prediction model by machine learning based on a result of the comparison. For example, the training unit 23 inputs the predicted image to an encoder model that converts a situation indicated by an image into text, and generates text indicating the predicted situation. Then, the training unit 23 may compare the text indicating the context with the text indicating the predicted situation, and update the state prediction model by machine learning using a difference (that is, a loss) between both texts. Alternatively, the training unit 23 may calculate a latent variable from both the text indicating the context and the predicted state (predicted image), and update the state prediction model by machine learning using a difference (loss) between both latent variables. Alternatively, the training unit 23 may use a predetermined comparison model that compares the text indicating the context with the predicted state (predicted image), and update the state prediction model by machine learning based on a comparison result obtained from the comparison model.

The generation of the evaluation model will be described. In one example, the sample database 22 stores in advance, as training data, a plurality of data records each indicating a combination of image data indicating a state of a workpiece being processed at a certain point in the past, a goal value set in advance in association with the workpiece, and an evaluation value set for the state of the workpiece. The training unit 23 generates the evaluation model by machine learning using that training data. In this machine learning, the training unit 23 uses the evaluation value indicated by the training data as ground truth.

The generation of the planning model will be described. In one example, the sample database 22 stores in advance, as training data, a plurality of data records each indicating a combination of image data indicating a state of a workpiece being processed at a certain time point in the past and a plan of a next task related to the workpiece. The plan of the next task may include a plan of a motion of the robot 2 in the next task. The training unit 23 generates the planning model by machine learning using that training data. In this machine learning, the training unit 23 uses the plan of the next task indicated by the training data as ground truth.

The generation of the trained model corresponds to a learning phase of machine learning. The prediction or estimation using the generated trained model corresponds to an operation phase of machine learning. The processing flows S1 and S2 above correspond to the operation phase.

It may be said that a combination of the control model, the state prediction model, and the evaluation model in the above examples is an instruction generation model that has been trained so as to output, in a case where at least image data (situation image) is input, designated posture data indicating a posture of the robot at a second point in time after a first point in time at which the image data is acquired. The next manipulated value may be interpreted as the designated posture data. Additional examples

It is to be understood that not all aspects, advantages and features described herein may necessarily be achieved by, or included in, any one particular example. Indeed, having described and illustrated various examples herein, it should be apparent that other examples may be modified in arrangement and detail.

The robot control system may control at least one of a plurality of real robots that cooperatively process a workpiece according to a current situation of a real working space in which the plurality of real robots are placed. For example, the robot control system controls each six-axis robot in an operation in which two six-axis robots cooperate to open a packaging material. The robot control system may execute the above-described processing flows S1 and S2 for at least one of the plurality of robots, for example, for each robot.

The control model may be trained to calculate, based on one of a sample image indicating the workpiece at a first point in time and a first manipulated value of the robot at the first point in time, a second manipulated value of the robot at a second point in time. In a case where the control model is used, the setting unit inputs one of the current manipulated value and the situation image to the control model to initially set the next manipulated value. Alternatively, the control model may be trained to calculate the second manipulated value based on at least one of the context, the goal value indicating the final goal or intermediate goal related to the workpiece, and the teaching point, in addition to at least one of the sample image and the first manipulated value. In a case where the control model is used, the setting unit inputs at least one of the current manipulated value and the situation image and at least one of the context, the goal value, and the teaching point to the control model to initially set the next manipulated value.

The simulation method and the configuration of the state prediction model are not limited to the above examples. For example, the simulation unit may input the set next manipulated value to the state prediction model trained to predict the state of the workpiece based on the next manipulated value, in order to generate the predicted state of the workpiece. Therefore, the simulation unit may generate the predicted state without using kinematics/dynamics and the renderer.

The trained model is portable between computer systems. The robot control system may not include functional modules corresponding to the data generation unit 21, the sample database 22, and the training unit 23 and may use a trained model generated by another computer system.

The adjustment unit may adjust the initially set next manipulated value, and the robot control unit may control the robot based on the adjusted next manipulated value. Therefore, the robot control system may not include a functional module corresponding to the iteration control unit 16.

The adjustment unit may adjust the next manipulated value without using the prediction evaluation value. For example, the adjustment unit may calculate a difference between the goal image indicating the goal value and the predicted image, and may adjust the next manipulated value based on the difference. For example, the adjustment unit may increase the adjustment amount of the next manipulated value as the difference increases. In such a modification, the robot control system may not include a functional module corresponding to the prediction evaluation unit 14.

The robot control system may not execute the process of determining whether or not to terminate the current task and controlling the robot. Alternatively, the robot control system may not execute the process of determining whether or not to change the action position in the current task and controlling the robot. Alternatively, the robot control system may not execute the process of planning the next task and terminating the current task according to a result of the planning. Therefore, the robot control system may not include a functional module corresponding to at least one of the status evaluation unit 17, the determination unit (part of the decision unit 19), and the planning unit 18.

In the above examples, the camera 4 captures the current situation of the working space 9, but another type of sensor different from the camera, such as a laser sensor, may detect the current situation of the actual working space.

The hardware configuration of the system is not limited to an aspect in which each functional module is realized by executing a program. For example, at least part of the above-described functional modules may be configured by a logic circuit specialized for the function, or may be configured by an application specific integrated circuit (ASIC) in which the logic circuit is integrated.

The processing procedure of the method executed by the at least one processor is not limited to the above example. For example, some of the steps or processes described above may be omitted, or the steps may be executed in a different order. In addition, any two or more of the above-described steps may be combined, or some of the steps may be modified or deleted. Alternatively, other steps may be executed in addition to the above-described steps.

When a magnitude relationship between two numerical values is compared in a computer system or a computer, either of two criteria of “equal to or greater than” and “greater than” may be used, and either of two criteria of “equal to or less than” and “less than” may be used.

### Appendix

As may be understood from the various examples described above, the present disclosure includes the following aspects.
(Appendix A1) A robot control system comprising:
a setting unit configured to initially set a next manipulated value in a current task for a robot placed in a real working space and executing the current task to process a workpiece;
a simulation unit configured to virtually execute, by simulation, the current task in which the robot operates with the next manipulated value to process the workpiece;
an adjustment unit configured to adjust the next manipulated value based on a prediction result obtained by the simulation; and
a robot control unit configured to control the robot in the real working space based on the adjusted next manipulated value.
   (Appendix A2) The robot control system according to appendix A1,
wherein the prediction result includes a predicted state that is a state of the workpiece having processed by the robot operating with the next manipulated value, and
wherein the adjustment unit is configured to adjust the next manipulated value based at least on the predicted state.
   (Appendix A3) The robot control system according to appendix A2, further comprising an evaluation unit configured to calculate an evaluation value of the predicted state of the workpiece based on a goal value preset in association with the workpiece,
wherein the adjustment unit is configured to adjust the next manipulated value based on the evaluation value.
   (Appendix A4) The robot control system according to appendix A3, further comprising:
an iteration control unit configured to control the simulation unit, the evaluation unit, and the adjustment unit so as to repeat the simulation, the calculation of the evaluation value, and the adjustment of the next manipulated value based on the evaluation value; and
a decision unit configured to conclude a final next manipulated value from a plurality of adjusted next manipulated values obtained by the repetition,
wherein the robot control unit is configured to control the robot based on the final next manipulated value.
   (Appendix A5) The robot control system according to any one of appendices A1 to A4, wherein the setting unit is configured to initially set the next manipulated value based on image data indicating the workpiece being processed by the robot in the real working space. (Appendix A6) The robot control system according to any one of appendices A1 to A5, wherein the setting unit is configured to input a current manipulated value of the robot processing the workpiece to a control model trained to calculate, based on a first manipulated value of the robot at a first point in time, a second manipulated value at a second point in time after the first point in time, and initially set the next manipulated value.
   (Appendix A7) The robot control system according to any one of appendices A2 to A4, wherein the simulation unit is configured to:
generate a virtual motion of the robot operating with the next manipulated value; and
input the generated virtual motion to a state prediction model trained to predict a state of the workpiece based on a motion of the robot, and generate the predicted state.
   (Appendix A8) The robot control system according to appendix A7,
wherein the simulation unit is configured to generate, as the predicted state, a temporal change of a virtual appearance state of the workpiece caused by the virtual motion, and
wherein the adjustment unit is configured to adjust the next manipulated value based at least on the temporal change of the virtual appearance state of the workpiece.
   (Appendix A9) The robot control system according to appendix A7 or A8, wherein the simulation unit is configured to input the generated virtual motion and a context relating to an element constituting the working space to a state prediction model trained to predict a state of the workpiece further based on the context, and generate the predicted state. (Appendix A10) The robot control system according to appendices A7 to A9, further comprising a training unit configured to update the state prediction model by machine learning using training data including a combination of the adjusted next manipulated value and an actual state that is a state of the workpiece having processed by the robot controlled by the robot control unit.
   (Appendix A11) The robot control system according to appendix A10, wherein the training unit is configured to:
receive a text as a context relating to an element constituting the working space;
compare the text and the predicted state, and update the state prediction model by machine learning based on a result of the comparison.
   (Appendix A12) The robot control system according to appendices A7 to A11, wherein the simulation unit is configured to generate an image indicating the virtual motion using a renderer based on the next manipulated value.
   (Appendix A13) The robot control system according to any one of appendices A1 to A12, further comprising:
an evaluation unit configured to calculate an evaluation value regarding an execution status of the current task based on a goal value preset in association with the workpiece; and
a determination unit configured to switch whether or not to continue the current task, based on the evaluation value,
wherein the robot control unit is configured to control the robot based on the switching.
   (Appendix A14) The robot control system according to any one of appendices A1 to A13, further comprising:
an evaluation unit configured to calculate an evaluation value regarding an execution status of the current task based on a goal value preset in association with the workpiece; and
a determination unit configured to determine, based on the evaluation value, whether or not to change an action position from a current position, wherein the action position is a position where the robot acts on the workpiece in the current task,
wherein the robot control unit is configured to, in a case where the action position is determined to be changed from the current position, cause the robot to change the action position from the current position to a new position and continue the current task.
   (Appendix A15) The robot control system according to any one of appendices A1 to A14, further comprising a planning unit configured to plan a next task following the current task based on a planning model and image data, wherein the image data indicates the workpiece being processed by the robot in the real working space, and wherein the planning model is trained to output a plan for the next task in response to the image data being input,
wherein the robot control unit is configured to control the robot according to a result of the planning by the planning unit to terminate the current task.
   (Appendix A16) The robot control system according to appendix A6, further comprising a training unit configured to update the control model by machine learning using training data including a combination of the current manipulated value and the adjusted next manipulated value.
   (Appendix A17) The robot control system according to appendix A16, further comprising a data generation unit configured to generate the training data,
wherein the simulation unit is configured to generate a predicted image indicating the predicted state of the workpiece based on a state prediction model and the next manipulated value, wherein the state prediction model is trained to generate the predicted image based on a motion of the robot operating with the next manipulated value and a context relating to an element constituting the working space,
wherein the data generation unit is configured to:
change the predicted image based on change information for changing a scene indicating the predicted state, and generate a training image indicating another state different from the predicted state;
generate the training data including a combination of the current manipulated value, the adjusted next manipulated value, and the training image, and
wherein the training unit is configured to update the control model or generate another control model for initially setting the next manipulated value, by machine learning using the training data further including the training image.
   (Appendix A18) A robot control method executable by a robot control system including at least one processor, the method comprising:
initially setting a next manipulated value in a current task for a robot placed in a real working space and executing the current task to process a workpiece;
virtually executing, by simulation, the current task in which the robot operates with the next manipulated value to process the workpiece;
adjusting the next manipulated value based on a prediction result obtained by the simulation; and
controlling the robot in the real working space based on the adjusted next manipulated value.
   (Appendix A19) A robot control program for causing a computer to execute:
initially setting a next manipulated value in a current task for a robot placed in a real working space and executing the current task to process a workpiece;
virtually executing, by simulation, the current task in which the robot operates with the next manipulated value to process the workpiece;
adjusting the next manipulated value based on a prediction result obtained by the simulation; and
controlling the robot in the real working space based on the adjusted next manipulated value.
   (Appendix A20) A robot control system comprising:
a robot configured to execute a current task on a workpiece;
an acquisition unit configured to sequentially acquire image data indicating the workpiece during execution of the current task;
a command generation unit configured to sequentially generate, based on an instruction generation model trained to output designated posture data indicating a posture of the robot at a second point in time after a first point in time at which the image data is acquired in a case where at least the image data is input, the designated posture data corresponding to the sequentially acquired image data;
a robot control unit configured to control the robot so as to execute the current task, based on the sequentially generated designated posture data.
   (Appendix A21) The robot control system according to the appendix A20, further comprising:
an evaluation unit configured to evaluate an execution status of the current task at a time point when the image data is acquired, based on an evaluation model trained to output an evaluation value related to an execution status of the current task in a case where at least the image data is input;
a determination unit configured to switch whether or not to continue the control of the robot based on the generated designated posture data, according to a result of the evaluation by the evaluation unit.
   (Appendix A22) The robot control system according to the appendix A21, further comprising a point of action extraction unit configured to extract a new point of action of the robot on the workpiece,
wherein the robot control unit is configured to control the robot so as to execute the current task while acting on the workpiece at the new point of action, in a case where the control of the robot is not continued. (Appendix A23) The robot control system according to the appendix A20, further comprising a planning unit configured to plan, based on the acquired image data and a planning model trained to output a plan of a next task following the current task in response to at least the image data being input, the next task,
wherein the robot control unit is configured to terminate the execution of the current task by the robot, according to a result of the planning by the planning unit.

According to appendices A1, A18 and A19, it is predicted how the robot will process the workpiece next in the current task that is actually being performed now, by the simulation based on the initially set next manipulated value. Then, the next manipulated value is adjusted based on the prediction result, and the robot in the actual working space is controlled based on the adjusted next manipulated value. Since the next manipulated value for continuing to control the robot is adjusted according to the prediction by the simulation of the current task, the robot may be appropriately operated according to a current situation of the actual working space. In addition, such appropriate robot control enables the current task and the workpiece to converge to a desired target state.

According to appendix A2, the state to which the workpiece is going to change in the current task is predicted by the simulation, and the next manipulated value is adjusted based on the prediction result. The state of the workpiece being processed by the robot is directly related to whether the current task succeeds or not. Therefore, by adjusting the next manipulated value based on slightly later state of the workpiece, the real robot may be caused to appropriately process the real workpiece according to the current situation of the real working space.

According to appendix A3, a subsequent state of the workpiece obtained by the simulation is evaluated based on the goal value associated with the workpiece, and a next manipulated value is adjusted based on the evaluation. It may be said that the goal value indicates the desired state of the workpiece. Since the next manipulated value is adjusted in consideration of the goal value, the real robot may be caused to appropriately process the real workpiece so as to bring the real workpiece into the desired state, according to the current situation of the real working space.

According to appendix A4, the adjustment of the next manipulated value based on the simulation and the evaluation of the prediction result is repeated, and then the next manipulated value for controlling the robot is finally determined. By repeating the adjustment, the real robot may be controlled with a more appropriate next manipulated value.

According to appendix A5, the next manipulated value is initially set based on the image data indicating the actual workpiece that is actually being processed. By using the image data clearly indicating the current situation of the workpiece, the next manipulated value may be initially set appropriately according to the situation. Therefore, the next manipulated value to be adjusted may also be expected to be a more appropriate value.

According to appendix A6, the next manipulated value is initially set by the control model (trained model) based on the current manipulated value of the real robot. By this processing, it is expected that the next manipulated value having continuity with the current manipulated value, that is, the next manipulated value for smoothly operating the real robot is more reliably obtained. Therefore, it may be expected that the next manipulated value to be adjusted also becomes an appropriate value that realizes smooth robot control in which the posture of the actual robot does not change rapidly.

According to appendix A7, a virtual motion of the robot that operates at the next manipulated value is generated, and the motion is input to a state prediction model (trained model) to predict the state of the workpiece being processed by the robot. By generating the predicted state from the virtual motion using the state prediction model, the state of the workpiece may be accurately predicted.

According to appendix A8, a temporal change in the virtual appearance state of the workpiece is generated as the predicted state, and the next manipulated value is adjusted based on the temporal change. In general, for a workpiece whose appearance state changes, it is difficult to predict how that appearance will change a little later. By adjusting the next manipulated value after predicting the change using the simulation, the robot may be caused to appropriately process the workpiece whose appearance state irregularly changes, according to the current situation.

According to appendix A9, a virtual motion of the robot that operates at the next manipulated value and the context related to an element constituting the working space are input to the state prediction model, and the state of the workpiece being processed by the robot is predicted. Since the state prediction model receives the input of the context and generates the predicted state, the predicted state may be generated for various types of workpieces. By introducing a general-purpose state prediction model capable of processing a plurality of types of workpieces and individually executing generation of the motion of the robot and generation of the predicted state of the workpiece in the simulation, general-purpose robot control that does not depend on a configuration element of the working space becomes possible. In addition, since it is not necessary to prepare the state prediction model for each configuration element of the working space, the number of steps of preparing the state prediction model may be reduced or suppressed.

According to appendix A10, the state prediction model for predicting the state of the workpiece may be updated by the machine learning, based on the actual state of the workpiece processed by the robot that is actually controlled based on the adjusted next manipulated value. The accuracy of the state prediction model may be further improved by the machine learning using new data obtained by actual robot control.

According to appendix A11, the state prediction model is updated by the machine learning based on the comparison result between the text indicating the context and the predicted state of the workpiece. This machine learning may realize the state prediction model that generates the predicted state in accordance with the context given in a text format.

According to appendix A12, the image showing the virtual motion of the robot is generated by the renderer. By using the renderer, the three-dimensional structure and the three-dimensional motion of the robot may be accurately represented by an image. As a result, the prediction result by the simulation may be obtained more accurately.

According to appendices A13 and A21, the execution status of the current task is evaluated based on the goal value related to the workpiece, and whether or not to continue the current task is switched (i.e., determined) based on that evaluation. Since the determination regarding the continuation of the current task is performed in consideration of the goal value that may be said to indicate the state of the workpiece to be aimed at, the current task may be appropriately continued or terminated according to the current situation of the actual working space.

According to appendices A14 and A22, the execution status of the current task is evaluated based on the goal value related to the workpiece, and whether or not to change the action position of the workpiece is determined based on the evaluation. Since the action position in the current task is controlled in consideration of the goal value that may be said to indicate the state of the workpiece to be aimed at, the workpiece may be appropriately processed in the current task according to the current situation of the actual working space.

According to appendices A15 and A23, the image data indicating the workpiece being processed by the current task is processed by the planning model (trained model), the next task following the current task is planned, and the current task is controlled according to a result of the planning. By controlling the current task in consideration of the plan of the next task rather than the current task itself, a series of processes from the current task to the next task may be smoothly performed.

According to appendix A16, the control model for initially setting the next manipulated value is updated by the machine learning based on the current manipulated value and the adjusted next manipulated value. The accuracy of the control model may be further improved by the machine learning using the next manipulated value actually used for the robot control.

According to appendix A17, from the predicted image that indicates the predicted state of the workpiece and is generated by the state prediction model in the simulation, the training image indicating another state different from the predicted state is generated. Then, the control model may be updated or newly generated by the machine learning based on the combination of the current manipulated value, the adjusted next manipulated value, and the training image. By the machine learning using the training image generated using the predicted image, the accuracy of the control model may be improved and a new control model according to a variation element in the working space may be prepared. In addition, number of steps for preparing the control model may be reduced or suppressed.

According to appendix A20, the image data indicating the workpiece at the first point in time that is being processed by the current task is generated based on the instruction generation model, and the designated posture data at the second point in time later than the first point in time is generated. Then, the robot is controlled to further execute the current task, based on the designated posture data. Since the designated posture data for continuously controlling the robot is generated according to the current situation of the current task, the robot may be appropriately operated according to the current situation of the actual working space. In addition, such appropriate robot control enables the current task and workpiece to converge to a desired goal state.

As may be understood from the various examples described above, the present disclosure also includes the following aspects.

(Appendix B1) A robot control system comprising circuitry configured to:
acquire observation data indicating a current situation of a real working space;
initially set, based on the observation data, a next manipulated value in a current task for a robot placed in the real working space and executing the current task to process a workpiece;
virtually execute, by simulation, the current task in which the robot operates with the next manipulated value to process the workpiece, and to generate, as a predicted state, a state of the workpiece processed by the robot;
calculate, based on a goal value preset in association with the workpiece, an evaluation value of the predicted state of the workpiece;
adjust the next manipulated value based on the evaluation value; and
control the robot in the real working space based on the adjusted next manipulated value.
   (Appendix B2) The robot control system according to appendix B1, wherein the circuitry is configured to cause the robot to execute the current task while sequentially generating the next manipulated values by repeating processing that includes: the initial setting of the next manipulated value; the virtual execution of the current task and the generation of the predicted state; the calculation of the evaluation value; the adjustment of the next manipulated value; and the control of the robot based on the adjusted next manipulated value.
   (Appendix B3) The robot control system according to appendix B2, wherein the circuitry is configured to:
repeat the virtual execution of the current task, the generation of the predicted state, the calculation of the evaluation value, and the adjustment of the next manipulated value based on the evaluation value;
conclude a final next manipulated value from a plurality of adjusted next manipulated values obtained by the repetition; and
control the robot based on the final next manipulated value.
   (Appendix B4) The robot control system according to appendix B1, wherein the circuitry is configured to initially set the next manipulated value based on image data indicating the workpiece being processed by the robot in the real working space.
   (Appendix B5) The robot control system according to appendix B1, wherein the circuitry is configured to, as at least part of the simulation:
execute kinematics/dynamics calculations based on the next manipulated value to generate a virtual motion of the robot operating with the next manipulated value; and
input the generated virtual motion to a state prediction model trained to predict a state of the workpiece based on a motion of the robot, and generate the predicted state.
   (Appendix B6) The robot control system according to appendix B5, wherein the circuitry is configured to, as at least part of the simulation, use a renderer based on the next manipulated value to generate a motion image indicating the virtual motion.
   (Appendix B7) The robot control system according to appendix B6, wherein the circuitry is configured to:
as at least part of the simulation, input the virtual motion indicated by the motion image to the state prediction model, and generate a predicted image indicating the predicted state; and
calculate the evaluation value based on the predicted image and a target image representing the goal value.
   (Appendix B8) The robot control system according to appendix B5, wherein the circuitry is configured to:
as at least part of the simulation, generate, as the predicted state, a temporal change of a virtual appearance state of the workpiece caused by the virtual motion, and
adjust the next manipulated value based at least on the temporal change of the virtual appearance state of the workpiece.
   (Appendix B9) The robot control system according to appendix B5, wherein the circuitry is configured to, as at least part of the simulation, input the generated virtual motion and a context relating to an element constituting the working space to the state prediction model trained to predict a state of the workpiece further based on the context, and generate the predicted state.
   (Appendix B10) The robot control system according to appendix B5, wherein the circuitry is configured to update the state prediction model by machine learning using training data including a combination of the adjusted next manipulated value and an actual state that is a state of the workpiece having processed by the controlled robot.
   (Appendix B11) The robot control system according to appendix B10, wherein the circuitry is configured to:
receive a text indicating a context relating to an element constituting the working space; and
compare the text and the predicted state, and update the state prediction model by machine learning based on a result of the comparison.
   (Appendix B12) The robot control system according to appendix B1, wherein the circuitry is configured to input a current manipulated value of the robot processing the workpiece to a control model trained to calculate, based on a first manipulated value of the robot at a first point in time, a second manipulated value at a second point in time after the first point in time, and initially set the next manipulated value.
   (Appendix B13) The robot control system according to appendix B12, wherein the circuitry is configured to update the control model by machine learning using training data including a combination of the current manipulated value and the adjusted next manipulated value.
   (Appendix B14) The robot control system according to appendix B13, wherein the circuitry is configured to:
generate a predicted image indicating the predicted state of the workpiece based on a state prediction model and the next manipulated value, wherein the state prediction model is trained to generate the predicted image based on a motion of the robot operating with the next manipulated value and a context relating to an element constituting the working space;
change the predicted image based on change information for changing a scene indicating the predicted state, and generate a training image indicating another state different from the predicted state;
generate the training data including a combination of the current manipulated value, the adjusted next manipulated value, and the training image; and
update the control model or generate another control model for initially setting the next manipulated value, by machine learning using the training data further including the training image.
   (Appendix B15) The robot control system according to appendix B1, wherein the circuitry is configured to:
calculate an evaluation value regarding an execution status of the current task based on a goal value preset in association with the workpiece;
switch whether or not to continue the current task, based on the evaluation value; and
control the robot based on the switching.
   (Appendix B16) The robot control system according to appendix B1, wherein the circuitry is configured to:
calculate an evaluation value regarding an execution status of the current task based on a goal value preset in association with the workpiece;
determine, based on the evaluation value, whether or not to change an action position from a current position, wherein the action position is a position where the robot acts on the workpiece in the current task; and
in a case where the action position is determined to be changed from the current position, cause the robot to change the action position from the current position to a new position and continue the current task.
   (Appendix B17) The robot control system according to appendix B1, wherein the circuitry is configured to:
plan a next task following the current task based on a planning model and image data, wherein the image data indicates the workpiece being processed by the robot in the real working space, and wherein the planning model is trained to output a plan for the next task in response to the image data being input; and
control the robot according to a result of the planning to terminate the current task.
   (Appendix B18) The robot control system according to appendix B1, wherein the circuitry is configured to adjust the next manipulated value such that a state of the workpiece becomes closer to the goal value than the predicted state.
   (Appendix B19) A robot control method executable by a robot control system including at least one processor, the method comprising:
acquiring observation data indicating a current situation of a real working space;
initially setting, based on the observation data, a next manipulated value in a current task for a robot placed in the real working space and executing the current task to process a workpiece;
virtually executing, by simulation, the current task in which the robot operates with the next manipulated value to process the workpiece, and generating, as a predicted state, a state of the workpiece processed by the robot;
calculating, based on a goal value preset in association with the workpiece, an evaluation value of the predicted state of the workpiece;
adjusting the next manipulated value based on the evaluation value; and
controlling the robot in the real working space based on the adjusted next manipulated value.
   (Appendix B20) A non-transitory computer-readable storage medium storing processor-executable instructions for causing a computer to execute:
acquiring observation data indicating a current situation of a real working space;
initially setting, based on the observation data, a next manipulated value in a current task for a robot placed in the real working space and executing the current task to process a workpiece;
virtually executing, by simulation, the current task in which the robot operates with the next manipulated value to process the workpiece, and generating, as a predicted state, a state of the workpiece processed by the robot;
calculating, based on a goal value preset in association with the workpiece, an evaluation value of the predicted state of the workpiece;
adjusting the next manipulated value based on the evaluation value; and
   controlling the robot in the real working space based on the adjusted next manipulated value.

What is claimed is:

1. A robot control system comprising circuitry configured to:
acquire observation data indicating a current situation of a real working space;
initially set, based on the observation data, a next manipulated value in a current task for a robot placed in the real working space and executing the current task to process a workpiece;
virtually execute, by simulation, the current task in which the robot operates with the next manipulated value to process the workpiece, and to generate, as a predicted state, a state of the workpiece processed by the robot;
calculate, based on a goal value preset in association with the workpiece, an evaluation value of the predicted state of the workpiece;
adjust the next manipulated value based on the evaluation value; and
control the robot in the real working space based on the adjusted next manipulated value.

2. The robot control system according to claim 1, wherein the circuitry is configured to cause the robot to execute the current task while sequentially generating the next manipulated values by repeating processing that includes: the initial setting of the next manipulated value; the virtual execution of the current task and the generation of the predicted state; the calculation of the evaluation value; the adjustment of the next manipulated value; and the control of the robot based on the adjusted next manipulated value.

3. The robot control system according to claim 2, wherein the circuitry is configured to:
repeat the virtual execution of the current task, the generation of the predicted state, the calculation of the evaluation value, and the adjustment of the next manipulated value based on the evaluation value;
conclude a final next manipulated value from a plurality of adjusted next manipulated values obtained by the repetition; and
control the robot based on the final next manipulated value.

4. The robot control system according to claim 1, wherein the circuitry is configured to initially set the next manipulated value based on image data indicating the workpiece being processed by the robot in the real working space.

5. The robot control system according to claim 1, wherein the circuitry is configured to, as at least part of the simulation:
execute kinematics/dynamics calculations based on the next manipulated value to generate a virtual motion of the robot operating with the next manipulated value; and
input the generated virtual motion to a state prediction model trained to predict a state of the workpiece based on a motion of the robot, and generate the predicted state.

6. The robot control system according to claim 5, wherein the circuitry is configured to, as at least part of the simulation, use a renderer based on the next manipulated value to generate a motion image indicating the virtual motion.

7. The robot control system according to claim 6, wherein the circuitry is configured to:
as at least part of the simulation, input the virtual motion indicated by the motion image to the state prediction model, and generate a predicted image indicating the predicted state; and
calculate the evaluation value based on the predicted image and a target image representing the goal value.

8. The robot control system according to claim 5, wherein the circuitry is configured to:
as at least part of the simulation, generate, as the predicted state, a temporal change of a virtual appearance state of the workpiece caused by the virtual motion, and
adjust the next manipulated value based at least on the temporal change of the virtual appearance state of the workpiece.

9. The robot control system according to claim 5, wherein the circuitry is configured to, as at least part of the simulation, input the generated virtual motion and a context relating to an element constituting the working space to the state prediction model trained to predict a state of the workpiece further based on the context, and generate the predicted state.

10. The robot control system according to claim 5, wherein the circuitry is configured to update the state prediction model by machine learning using training data including a combination of the adjusted next manipulated value and an actual state that is a state of the workpiece having processed by the controlled robot.

11. The robot control system according to claim 10, wherein the circuitry is configured to:
receive a text indicating a context relating to an element constituting the working space; and
compare the text and the predicted state, and update the state prediction model by machine learning based on a result of the comparison.

12. The robot control system according to claim 1, wherein the circuitry is configured to input a current manipulated value of the robot processing the workpiece to a control model trained to calculate, based on a first manipulated value of the robot at a first point in time, a second manipulated value at a second point in time after the first point in time, and initially set the next manipulated value.

13. The robot control system according to claim 12, wherein the circuitry is configured to update the control model by machine learning using training data including a combination of the current manipulated value and the adjusted next manipulated value.

14. The robot control system according to claim 13, wherein the circuitry is configured to:
generate a predicted image indicating the predicted state of the workpiece based on a state prediction model and the next manipulated value, wherein the state prediction model is trained to generate the predicted image based on a motion of the robot operating with the next manipulated value and a context relating to an element constituting the working space;
change the predicted image based on change information for changing a scene indicating the predicted state, and generate a training image indicating another state different from the predicted state;
generate the training data including a combination of the current manipulated value, the adjusted next manipulated value, and the training image; and
update the control model or generate another control model for initially setting the next manipulated value, by machine learning using the training data further including the training image.

15. The robot control system according to claim 1, wherein the circuitry is configured to:
calculate an evaluation value regarding an execution status of the current task based on a goal value preset in association with the workpiece;
switch whether or not to continue the current task, based on the evaluation value; and
control the robot based on the switching.

16. The robot control system according to claim 1, wherein the circuitry is configured to:
calculate an evaluation value regarding an execution status of the current task based on a goal value preset in association with the workpiece;
determine, based on the evaluation value, whether or not to change an action position from a current position, wherein the action position is a position where the robot acts on the workpiece in the current task; and
in a case where the action position is determined to be changed from the current position, cause the robot to change the action position from the current position to a new position and continue the current task.

17. The robot control system according to claim 1, wherein the circuitry is configured to:
plan a next task following the current task based on a planning model and image data, wherein the image data indicates the workpiece being processed by the robot in the real working space, and wherein the planning model is trained to output a plan for the next task in response to the image data being input; and
control the robot according to a result of the planning to terminate the current task.

18. The robot control system according to claim 1, wherein the circuitry is configured to adjust the next manipulated value such that a state of the workpiece becomes closer to the goal value than the predicted state.

19. A robot control method executable by a robot control system including at least one processor, the method comprising:
acquiring observation data indicating a current situation of a real working space;
initially setting, based on the observation data, a next manipulated value in a current task for a robot placed in the real working space and executing the current task to process a workpiece;
virtually executing, by simulation, the current task in which the robot operates with the next manipulated value to process the workpiece, and generating, as a predicted state, a state of the workpiece processed by the robot;
calculating, based on a goal value preset in association with the workpiece, an evaluation value of the predicted state of the workpiece;
adjusting the next manipulated value based on the evaluation value; and
controlling the robot in the real working space based on the adjusted next manipulated value.

20. A non-transitory computer-readable storage medium storing processor-executable instructions for causing a computer to execute:
acquiring observation data indicating a current situation of a real working space;
initially setting, based on the observation data, a next manipulated value in a current task for a robot placed in the real working space and executing the current task to process a workpiece;
virtually executing, by simulation, the current task in which the robot operates with the next manipulated value to process the workpiece, and generating, as a predicted state, a state of the workpiece processed by the robot;
calculating, based on a goal value preset in association with the workpiece, an evaluation value of the predicted state of the workpiece;
adjusting the next manipulated value based on the evaluation value; and
controlling the robot in the real working space based on the adjusted next manipulated value.
